(19) United States
(12) Patent Application Publication
(10) Pub. No.: US 2002/0077718 A1
(43) Pub. Date: Jun. 20, 2002

(54) Method and system for electronic raw material tracking and quality control

(76) Inventors: Scott S. Harburda, Clinton, IN (US); Rex E. Masterson, Evansville, IN (US); Angelika H. Clark, Mt. Vernon, IN (US); Michael S. Davis, Mt. Vernon, IN (US); George E. McCarty, Mt. Vernon, IN (US)

Correspondence Address: Deborah B. Crenshaw, Esq., Cantor Colburn LLP, 55 Griffin Road South, Bloomfield, CT, 06002, US

(21) Appl. No.: 09/745,085

(22) Filed: Dec. 20, 2000

(51) Int. Cl. G06F 19/00

(52) U.S. Cl. 700/106

(57) ABSTRACT

An exemplary embodiment is a method and system for electronic raw material tracking and quality control. The system includes a processor integrated with the production line for receiving inventory data corresponding to raw material for the product, generating an electronic production schedule for the product, generating an electronic production run sheet including the inventory data, receiving a product selection from the electronic production schedule, receiving a quantity selection for the product from the electronic production schedule, downloading data from the electronic production schedule to the electronic production run sheet and determining whether the raw material is acceptable for the product in the quantity based on the inventory data. A network is connected to the processor, and a user system is coupled to the network for accessing the electronic production schedule and the electronic production run sheet. A database is coupled to the processor for storing data relating to the production line.

### BACKGROUND

The invention relates generally to production line management, and more specifically, to a method and system for electronic raw material tracking and quality control.

Many production lines, such as in the plastics industries, involve numerous processes to create an end product. In production lines where intricate or otherwise information-sensitive manufacturing is performed, correctly transferring critical production information is essential. Any number of factors may be significant to the proper running of the production line at any given time, but without the efficient, fast and accurate transfer of this information, numerous errors may occur.

For example, in the finishing of plastic pellets (which have been produced previously in a resin process), the finishing process encompasses adding various materials to the pellets. The added materials may be flame-retardants, pigment, glass, etc., depending on the final use thereof. After the addition, or what is typically called the compounding process, the pellets are extruded into an end product.

Typically, a production operator is required to manually enter the production equipment settings, such as temperatures, feeder rates, and equipment speeds. Further, information such as lot number, production identification, production settings, production readings and quality assurance (QA) data (such as physical properties and visual inspection results) are manually entered onto a production “run sheet.” Manual entry to the run sheet is required every time a new product, or production lot, is run on each production line (approximately once every eight hours for each production line). The task is manually intensive, requiring the operator to: 1) search for an appropriate unique control plan; 2) enter each setting on the equipment; and 3) write each setting on the run sheet. Therefore, valuable operator time is used, and manual entry often results in clerical data entry errors that may affect the quality and consistency of the products being produced. Moreover, the operator is often required to search for the handwritten data, which may be located in several different locations throughout the production site. In other words, the current practices are ripe for error.

Routinely, production is performed with very little information or knowledge about the inputs to the manufacturing process, namely the raw material and its physical properties. This lack of information may make it difficult for manufacturing engineers and quality specialists to improve the quality of products, especially when trying to determine the root cause of a problem. Further, tracking the location of a specific raw material and its available quantity within the manufacturing facility or facilities may be difficult. In other words, determining raw material availability, and its location, typically requires manually intensive logistical efforts. Also, without having accurate information regarding raw material inventory, the raw material maintenance and storage expenses can be costly. In addition, statistical information regarding the raw material's physical properties is not typically collected. Therefore, controlling the quality of the raw materials (thus, the quality of the end product) used in a production line may be difficult. Even further, the individual(s) responsible for any problems, produced as a result of errors with raw material inventory, is not typically identified. Therefore, a lack of accountability may exist.

Thus, there is a need for a more efficient, fast and accurate method and system for raw material tracking and quality control.

### SUMMARY

An exemplary embodiment is a method and system for electronic raw material tracking and quality control. The system includes a processor integrated with the production line for receiving inventory data corresponding to raw material for the product, generating an electronic production schedule for the product, generating an electronic production run sheet including the inventory data, receiving a product selection from the electronic production schedule, receiving a quantity selection for the product from the electronic production schedule, downloading data from the electronic production schedule to the electronic production run sheet and determining whether the raw material is acceptable for the product in the quantity based on the inventory data. A network is connected to the processor, and a user system is coupled to the network for accessing the electronic production schedule and the electronic production run sheet. A database is coupled to the processor for storing data relating to the production line.

### BRIEF DESCRIPTION OF THE DRAWINGS

Referring now to the drawings wherein like elements are numbered alike in several FIGURES:

FIG. 1 depicts an exemplary electronic production run sheet in an embodiment of the invention.

FIG. 2 is a block diagram of a computer system in an embodiment of the invention.

FIG. 3 depicts an exemplary method for determining raw material inventory in an embodiment of the invention.

FIGS. 4A and 4B illustrate an exemplary method for electronic raw material tracking and quality control in an embodiment of the invention.

### DETAILED DESCRIPTION

This application relates generally to commonly owned and invented U.S. application Ser. No. 09/498,035, filed Feb. 4, 2000, entitled “Method and System for Electronically Capturing, Storing, Searching and Retrieving Production Data,” the teachings of which are incorporated by reference herein.

As previously discussed, typically, the production operator is required to manually enter information to the run sheet every time a new product or production lot is run on each production line. In contrast, the invention does not require such manual entry, and therefore, the errors and problems associated with manual entry of production line data are eliminated. Therefore, productivity is increased and costs are reduced. Further, the quality and consistency of the products produced on the production line are improved by eliminating errors and problems associated with manual entry methods. Also, historical analysis of the production line data is quicker and more accurate. The information contained in the electronic production run sheet 80 helps to insure that only “quality” raw materials are used to produce the product, improve the analysis of the product (such as providing useful information for determining the root cause of a problem) and optimize the production process through improved tracking of the identity, location, quantity and physical properties of the raw materials to be used in the product.

Furthermore, cumbersome manual logistical tracking techniques are eliminated by the use of a method and system that electronically tracks the raw material. Thus, the raw material may be efficiently and accurately tracked and delivered to the production equipment without the errors and problems associated with manual logistical tracking techniques. For example, raw material inventory data may be entered to a database by merely scanning a bar-coded label associated with the raw material. Further, the raw material inventory data may include the raw material's physical properties, thus, allowing for greater quality control. Of course, greater quality control allows for improved product consistency, simplified root cause analysis and reduced raw material waste. Plus, improvements in predicting and eliminating production downtime (due to shortages, location and/or quality problems with the raw material) are achieved.

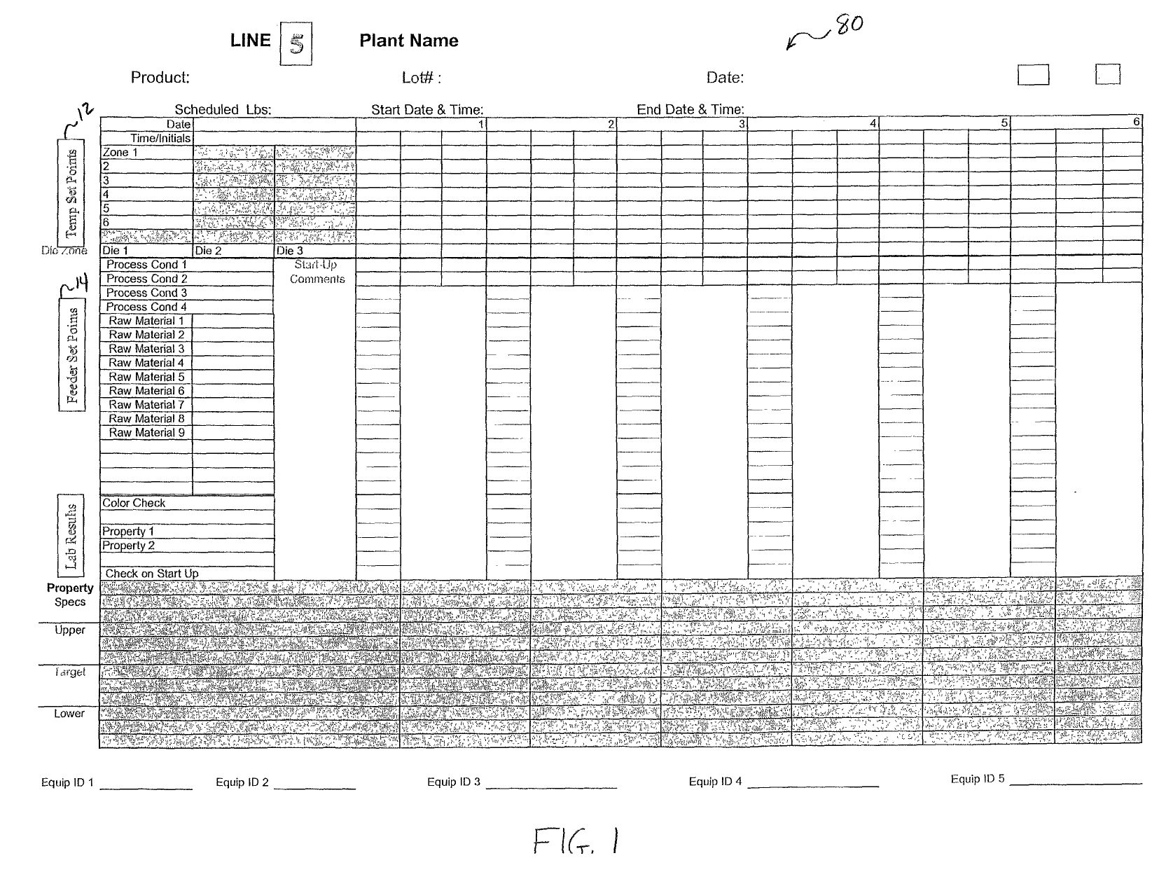

In general, an embodiment includes an electronic production run sheet 80, FIG. 1, containing production readings and quality data for a particular production line product. The manual version of a run sheet is usually in a tabular form with various columns in which the operator must record the production information by hand. After recording the product and lot number, date and time, the operator must hand write the temperature set points at 12 for the various zones of the extruder. The operator must also record various feeder set points 14.

Although the system of an embodiment is described with relation to plastics finishing, it should be appreciated that the system and method described herein can be applied to various other manufacturing and data retrieval and storage environments.

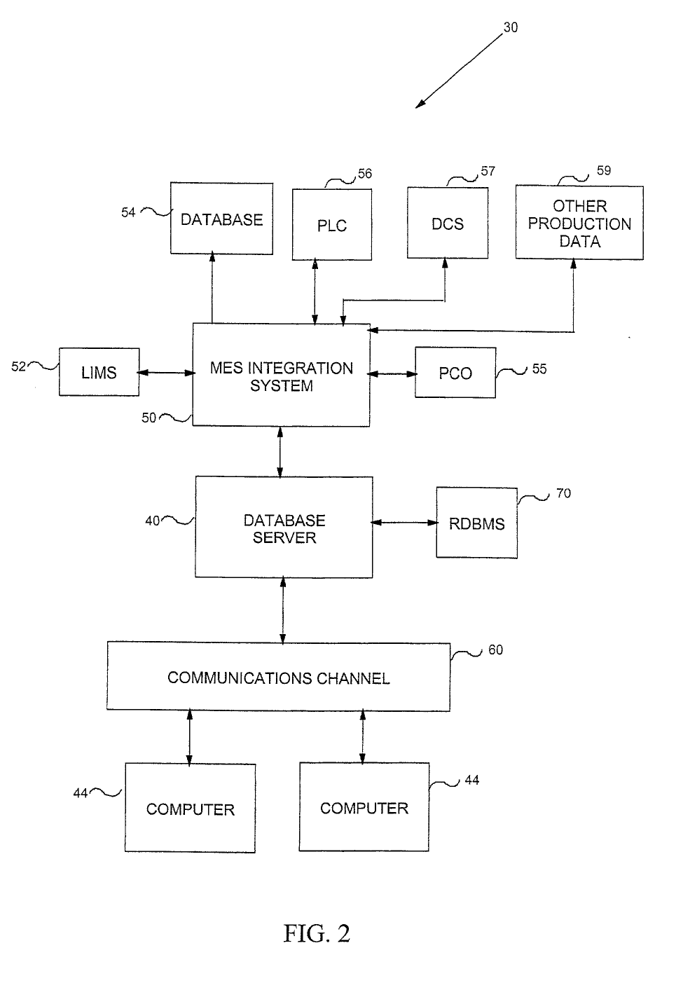

An embodiment utilizes a manufacturing execution system (MES) computer system 30. Referring to FIG. 2, the computer architecture of the MES computer system 30 will be described. The MES computer system 30 includes a database server 40 and computers 44. Although only two computers 44 are shown for simplicity it should be appreciated that a plurality of computers can be located at different locations in the production site for use by a plurality of operators. Moreover the database server 40 can be identical to computer 44 and is distinguishable as an embodiment only in that server 40 is the primary data storage source with which data stored in computers 44 can be synchronized therewith.

Computer(s) 44 are coupled to the database server 40 by communications channel 60. Communications channel 60 can be a network, such as a wide area network (WAN), local area network (LAN), Ethernet, intranet, a direct cable connection, a connection via phone lines and modems, or the like. Further, communications channel 60 can be continuous or intermittent and can be any mechanism for providing the communications described below. For example, communications channel 60 can include removable media, such as a diskette. Data can be sent over communications channel 60 in any appropriate format, such as e-mail in simple mail transfer protocol (SMTP), as attachments to email, as ASCII or binary files using file transfer protocol (FTP), or the like.

Even further, communications channel 60 can be the Internet. In such an embodiment, computer(s) 44 execute a user application (e.g., web browser) for interacting with the database server 40. Communication with computer(s) 44 can be achieved in any manner consistent with Internet information transfer, including but not limited to, HTTP and FTP, or a client/server connection.

Likewise, system components may be located remotely from each other and coupled via communications channel 60. For example, the database server 40 may be located off-site of the production line and communicates with corresponding components via communications channel 60 as a network, such as the Internet, WAN, LAN, Ethernet, intranet, a direct cable connection, a connection via phone lines and modems, or the like. Such remote locating is useful if, for example, the production facility environment is too extreme for the components.

The database server 40 is managed by a relational database management system (RDBMS) 70, such as the ORACLE RELATIONAL DATABASE MANAGEMENT SYSTEM by Oracle Corporation of Redwood Shores, California. RDBMS 70 manages a relational database to store the data. The data records, data tables, and data relationships contained in the database managed by RDBMS 70 enable the MES computer system 30 to provide increased reliability in searching and analyzing quality assurance (QA) lab testing data.

In the MES computer system 30, the database server 40 is a computer having sufficient resources to support RDBMS 70. Moreover, the database server 40 supports multi-operator access to RDBMS 70 over a computer network. Each operator computer terminal 44 should be sufficient to support an operating system such as WINDOWS 98, UNIX or other similar operating systems. These systems are used for communication with the Laboratory Information Management System (LIMS) 52, which executes on computers 44, as well.

The MES computer system 30 includes a variety of features. Data exchange between the database server 40 and the different databases, such as LIMS 52, can occur due to the use of the MES integration system 50. This acts as an interface between the database server 40 and LIMS 52, database 54, process control operations (PCO) system 55 for controlling the production equipment operations, programmable logic controller (PLC) interface 56 with production real-time data or distributed control system (DCS) 57 and other additional production data, such as scheduling via other production data database 59. Data exchange also occurs due to the use of a compliant language such as VISUAL BASIC (VB) from Microsoft Corporation of Redmond, Wash. For example, the line schedule can be determined via VB application programming interface (API) to the RDBMS 70 and other databases. If necessary, functionality modules can be used to group the production data by batches or lots. The line schedule also can be determined via various methods, such as manually, via database 54 or via an electronic schedule program interfaced with the RDBMS 70.

Data can be maintained for at least three years due to VB API access and a 40-gigabyte RAID-5-disk array. The particular storage amount is dependent upon the storage capacity, whereas the required length of storage is dependent upon policy dictating document retention.

Feeder rate settings of the extruder can be displayed from database 54 due to VB API and the DATABASE RDBMS interface. Generic production settings (such as feeders, temperatures, etc.) can be downloaded from other system databases. This could be sent to the PLC interface 56 or to the electronic production run sheet 80 via the MES interfaces.

RDBMS 70 also allows for the operator to manually enter operator comments for each line check. This is also accomplishable by the VB API access to RDBMS 70 and other databases. The VB API is a visual basic program, which allows for an additional field in the database system, which can store the operator comments. There is a control function, or button on the electronic production run sheet 80 which will allow the operator to enter and to display comments for each line check of for the entire production run. The VB API program will prompt the operator to enter his/her data and will then send it to the appropriate database system.

The VB API program also allows the operator to print a hard copy of the electronic production run sheet 80 and to print a pre-configured report for the production run. This will retrieve the appropriate batch (or lot) production and QA lab test data for printout on the pre-configured report format, similar to the one displayed in FIG. 1.

The system can include production alarms to indicate that a feeder has stopped or a product property is no longer within specification. These alarms are available in the electronic production run sheet 80 which allow operators the required information in real-time to make corrections. The database system contains the appropriate tolerances for the parameters and other software, such as TELALERT. It also contains the appropriate alarming system for activating alarms such as lights, horns, etc. The electronic production run sheet 80 contains a graphical alarm and a text display indicating what the alarm is for.

The database server 40 acts as a universal user interface due to RDMS 70, GE 90-70 PLC interface 56, EDCP RDBMS, VB API access. Furthermore, utilizing standard technology and tool sets such as VB, structured query languages (SQL), object linking and embedding (OLE) for process control, open database connectors (ODBC) and ActiveX controls also allow for universal user interface.

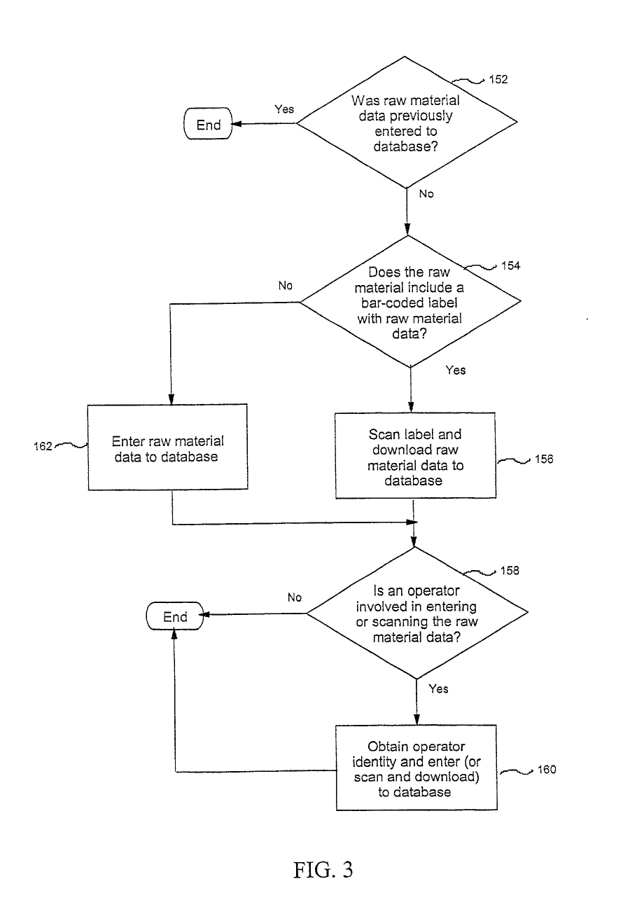

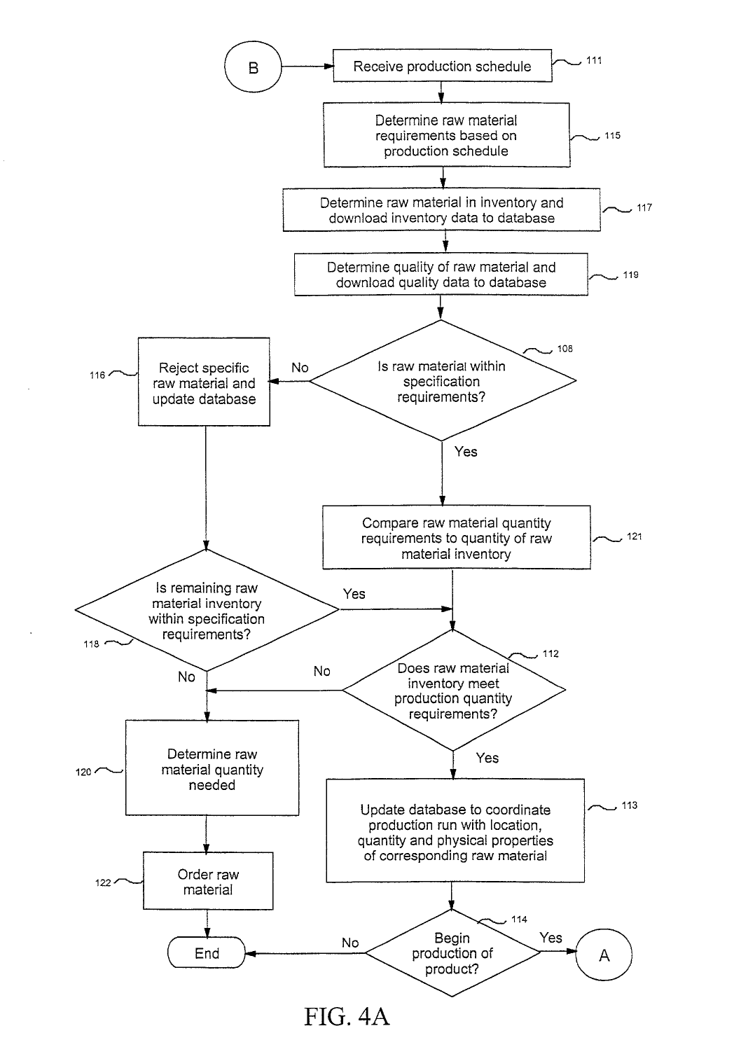

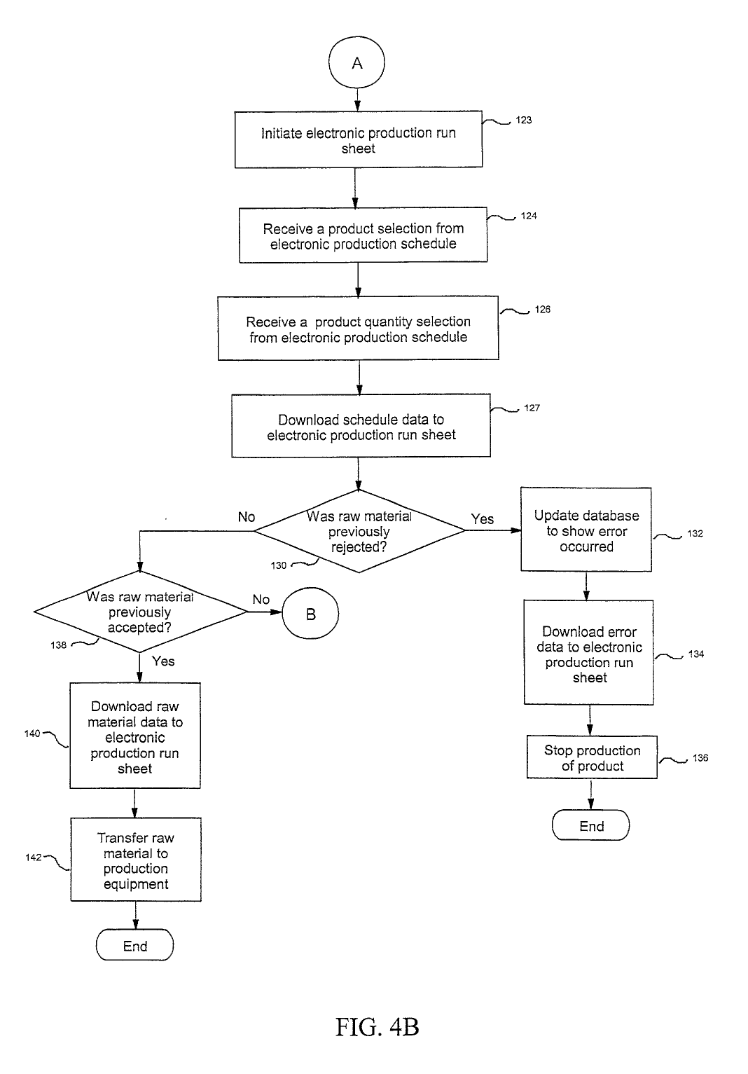

FIGS. 4A and 4B illustrate an exemplary method for electronic raw material tracking and quality control. The method of FIGS. 4A and 4B may be implemented by an operator using one of the computer(s) 44 or even automatically based on production schedule information previously entered to the MES computer system 30. First, in step 111, a production schedule is received. The production schedule may be previously stored in the database for retrieval by an operator. The production schedule may include the quantity, production line, time and date for producing a particular product. Next, in step 115, the raw material requirements are determined based on the information in the production schedule. Then, in step 117, the existing raw material in inventory is determined and the inventory data is downloaded to the database. The inventory may include “lots”/“batches” of raw material that have unique codes or assignments for identifying the particular lot/batch. A flow chart of an exemplary method for determining the existing raw material in inventory is shown in FIG. 3, and discussed later.

In step 119, the quality of the raw material is determined and the quality data is downloaded to the database. Determining the raw material quality may be accomplished by comparing the physical properties (such as viscosity and molecular weight) of the raw material to a specification requirement. This may be done with standard tests using common lab instruments. The quality data may be received several ways. For example, the quality data may be received directly from the raw material vendor and entered manually or automatically (such as using bar-code scanning techniques) to the database. Also, the quality data may be received at the production facility in a quality control laboratory and entered manually or automatically (such as through the LIMS) to the database. The quality data may even be obtained statistically using samples tested in the quality control laboratory.

Step 108 determines whether the raw material is within the specification requirement. If a batch of raw material is within the specification requirement, then in step 121, the quantity of raw material required is compared to the quantity in the raw material inventory. The next step proceeds to step 112, as discussed below. If a batch of the raw material is not within the specification requirement, in step 116, the batch of raw material is rejected and the inventory data is updated to show the rejection. The properties falling outside the specification requirements may also be indicated or flagged. The inventory data may be changed to identify the batch of raw material as “rejected,” and thereafter coded so that the material will not be allowed for use in production. For example, a code may be associated with the rejected batch of raw material that automatically sends an alarm to the operator if the rejected raw material is erroneously transferred to the production equipment (via the electronic production run sheet 80), or even interlocks the production equipment to prevent the rejected raw material from being transferred to the production equipment. The interlock may be in any form (such as mechanical, electrical and/or computer program) that will prevent the production equipment from operating, if needed. Step 118 determines whether the remaining raw material is within the specification requirement. If not, in step 120, the quantity of “new” raw material still needed is determined, and the raw material is ordered in step 122. If, in step 118, the remaining raw material is within the specification requirement, then step 112 determines whether the “accepted” raw material meets the production quantity requirement. If not, then, in steps 120 and 122, the quantity of “new” raw material still needed is determined and ordered. If, in step 112, the raw material inventory meets the production quantity requirements, then, in step 113, the database is updated so that the data for each production run may include the location, quantity and physical properties of the corresponding “accepted” raw material. This data may be downloaded to the electronic run sheet 80 for tracking the raw material used on a specific production run. Next, step 114 determines whether to begin production.

If, in step 114, production is to begin, then in step 123, the electronic production run sheet 80 is initiated. The electronic production run sheet 80 may be initiated automatically or by operator selection. Then in step 124, a product is selected from an electronic production schedule. Otherwise, the process ends. The electronic production schedule is an electronic version of the production schedule and may be integral to, or accessed by the electronic production run sheet 80. Product selection can be determined any number of ways, such as by selecting the product according to its unique production lot number or serial number. The production lot number can correspond to a particular product grade, color, customer and production line. Note that the steps leading up to step 124 may be previously completed, and the database may archive the data until step 124 is performed. Furthermore, other embodiments may include performing those same steps subsequent to step 124. In step 126, the quantity of the product to be produced is selected from the electronic production schedule. In step 127, the electronic production schedule data is downloaded to the electronic production run sheet 80. The data transfer may be automatic or via operator prompting and selecting. Next, step 130 determines whether the raw material was previously rejected. This helps prevent batches of rejected raw material (that may be reintroduced into the raw material inventory) from being used. If the raw material was previously rejected, then in step 132, the database is updated to show that a batch of rejected raw material was erroneously reintroduced to inventory. Then, in step 134, the data showing that an error occurred is downloaded to the electronic production run sheet, and in step 136, production is stopped. Again, production may be stopped by sending an alarm to the operator or interlocking the production equipment.

If, in step 130, the raw material was not previously rejected, then step 138 determines whether the raw material was previously accepted. If not, then the process (beginning with step 111) is repeated. Otherwise, in step 140, the raw material data is downloaded to the electronic production run sheet, and in step 142, the raw material is transferred to the production equipment. The actual raw material usage may be monitored and included on the electronic production run sheet 80 to allow for adjustments and future raw material purchases and production planning. Due to the variety of information that may be included on the electronic production run sheet 80, the raw material usage may be monitored according to production run, product, operator and/or other properties, such as a particular production process. This information may be received several ways. For example, the information may be entered via keyed entry, voice input, bar-code type scanning of identification labels, and the information may even be automatically entered based on production information previously entered to the MES computer system 30.

As discussed, FIG. 3 is a flow chart of an exemplary method for determining the raw material inventory. First, step 152 determines whether the raw material data was previously entered to the database. As discussed, an embodiment utilizing the MES computer system 30 may include the RDBMS for managing the relational database to store the data. Again, the inventory data may include raw material type, quantity, location and physical properties (and even whether a quality test has been conducted). If the raw material data was previously entered, the steps of FIG. 3 are not needed. Otherwise, step 154 determines whether the raw material includes a bar-coded label with raw material data. The bar-coded label may contain information such as material type, quantity, lot number, physical properties, destination location and any other useful information. If the raw material does not include a bar-coded label, then in step 162, the raw material data is entered to the database. In step 162, the information may be entered via keyed entry, voice input and even automatically entered based on production information previously entered to the MES computer system 30. However, if the raw material includes a bar-coded label with raw material data, then in step 156, the bar-coded label is scanned and the data is downloaded to the database. Then, step 158 determines whether an operator is involved in entering the raw material data or scanning the bar-coded label. If not, the process ends. Otherwise, in step 160, the operator's identity is received and downloaded to the database. The operator's identity may be useful when determining accountability for errors or raw material usage. Again, the operator's identity may be received several ways, such as via keyed entry, voice input, bar-code type scanning of the operator's identification badge, and the identity may even be automatically entered based on production information previously entered to the MES computer system 30.

The description applying the above embodiments is merely illustrative. As described above, embodiments in the form of computer-implemented processes and apparatuses for practicing those processes may be included. Also included may be embodiments in the form of computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. Also included may be embodiments in the form of computer program code, for example, whether stored in a storage medium, loaded into and/or executed by a computer, or as a data signal transmitted, whether a modulated carrier wave or not, over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed for carrying out this invention, but that the invention will include all embodiments falling within the scope of the appended claims.

What is claimed is:

1. A system for electronic raw material tracking and quality control corresponding to a product on a production line, the system comprising:
a processor integrated with said production line for receiving inventory data corresponding to raw material for said product, generating an electronic production schedule for said product, generating an electronic production run sheet including said inventory data, receiving a product selection from said electronic production schedule, receiving a quantity selection for said product from said electronic production schedule, downloading data from said electronic production schedule to said electronic production run sheet and determining whether said raw material is acceptable for said product in said quantity based on said inventory data;
a network connected to said processor;
a user system coupled to said network, said user system accessing said electronic production schedule and said electronic production run sheet; and
a database coupled to said processor for storing data relating to said production line.

2. The system of claim 1, wherein said determining whether said raw material is acceptable includes:
determining the quality of said raw material;
updating said inventory data based on said determining the quality of said raw material; and
determining a usable quantity of said raw material based on said updating said inventory data.

3. The system of claim 2, further including:
determining raw material requirements based on said electronic production schedule; and
determining whether said usable quantity of said raw material meets said raw material requirements.

4. The system of claim 3, further including commencing production of said product if said usable quantity of said raw material meets said raw material requirements.

5. The system of claim 3, further including receiving additional raw material if said usable quantity of said raw material does not meet said raw material requirements.

6. The system of claim 2, wherein said determining the quality of said raw material includes:
comparing the physical properties of said raw material to a raw material specification; and
determining whether said physical properties of said raw material are within said raw material specification.

7. The system of claim 1, wherein said receiving inventory data includes:
receiving the identity and quantity of said raw material; and
receiving the identity of an operator responsible for entering the identity and quantity of said raw material.

8. The system of claim 1, further including commencing production of said product if said raw material is acceptable.

9. The system of claim 8, further including receiving quality data for said product.

10. The system of claim 9, wherein said generating further includes said electronic production run sheet including said quality data for said product.

11. The system of claim 9, wherein said receiving quality data is performed at a predetermined interval.

12. The system of claim 9, wherein said receiving quality data occurs automatically in response to a change in said quality data which is greater than a predetermined threshold.

13. The system of claim 8, further including receiving production line data for said product.

14. The system of claim 13, wherein said generating further includes said electronic production run sheet including said production line data for said product.

15. The system of claim 13, wherein said receiving production line data is performed at a predetermined interval.

16. The system of claim 13, wherein said receiving production line data occurs automatically in response to a change in said production line data which is greater than a predetermined threshold.

17. The system of claim 1, wherein said generating further includes supplemental user comments.

18. A method for electronic raw material tracking and quality control corresponding to a product on a production line, the method comprising:
receiving inventory data corresponding to raw material for said product;
generating an electronic production schedule for said product;
generating an electronic production run sheet including said inventory data;
receiving a product selection from said electronic production schedule;
receiving a quantity selection for said product from said electronic production schedule;
downloading data from said electronic production schedule to said electronic production run sheet; and
determining whether said raw material is acceptable for said product in said quantity based on said inventory data.

19. The method of claim 18, wherein said determining whether said raw material is acceptable includes:
determining the quality of said raw material;
updating said inventory data based on said determining the quality of said raw material; and
determining a usable quantity of said raw material based on said updating said inventory data.

20. The method of claim 19, further including:
determining raw material requirements based on said electronic production schedule; and
determining whether said usable quantity of said raw material meets said raw material requirements.

21. The method of claim 20, further including commencing production of said product if said usable quantity of said raw material meets said raw material requirements.

22. The method of claim 20, further including receiving additional raw material if said usable quantity of said raw material does not meet said raw material requirements.

23. The method of claim 19, wherein said determining the quality of said raw material includes:
comparing the physical properties of said raw material to a raw material specification; and
determining whether said physical properties of said raw material are within said raw material specification.

24. The method of claim 18, wherein said receiving inventory data includes:
receiving the identity and quantity of said raw material; and
receiving the identity of an operator responsible for entering the identity and quantity of said raw material.

25. The method of claim 18, further including commencing production of said product if said raw material is acceptable.

26. The method of claim 25, further including receiving quality data for said product.

27. The method of claim 26, wherein said generating further includes said electronic production run sheet including said quality data for said product.

28. The method of claim 26, wherein said receiving quality data is performed at a predetermined interval.

29. The method of claim 26, wherein said receiving quality data occurs automatically in response to a change in said quality data which is greater than a predetermined threshold.

30. The method of claim 25, further including receiving production line data for said product.

31. The method of claim 30, wherein said generating further includes said electronic production run sheet including said production line data for said product.

32. The method of claim 30, wherein said receiving production line data is performed at a predetermined interval.

33. The method of claim 30, wherein said receiving production line data occurs automatically in response to a change in said production line data which is greater than a predetermined threshold.

34. The method of claim 18, wherein said generating further includes supplemental user comments.

35. A storage medium encoded with machine-readable computer program code for electronic raw material tracking and quality control corresponding to a product on a production line, said storage medium including instructions for causing a processor to implement a method comprising:
receiving inventory data corresponding to raw material for said product;
generating an electronic production schedule for said product;
generating an electronic production run sheet including said inventory data;
receiving a product selection from said electronic production schedule;
receiving a quantity selection for said product from said electronic production schedule;
downloading data from said electronic production schedule to said electronic production run sheet; and
determining whether said raw material is acceptable for said product in said quantity based on said inventory data.

36. The storage medium of claim 35, wherein said determining whether said raw material is acceptable includes instructions for causing said processor to implement:
determining the quality of said raw material;
updating said inventory data based on said determining the quality of said raw material; and
determining a usable quantity of said raw material based on said updating said inventory data.

37. The storage medium of claim 36, further including instructions for causing said processor to implement:
determining raw material requirements based on said electronic production schedule; and
determining whether said usable quantity of said raw material meets said raw material requirements.

38. The storage medium of claim 37, further including instructions for causing said processor to implement commencing production of said product if said usable quantity of said raw material meets said raw material requirements.

39. The storage medium of claim 37, further including instructions for causing said processor to implement receiving additional raw material if said usable quantity of said raw material does not meet said raw material requirements.

40. The storage medium of claim 36, wherein said determining the quality of said raw material includes instructions for causing said processor to implement:
comparing the physical properties of said raw material to a raw material specification; and
determining whether said physical properties of said raw material are within said raw material specification.

41. The storage medium of claim 35, wherein said receiving inventory data includes instructions for causing said processor to implement:
receiving the identity and quantity of said raw material; and
receiving the identity of an operator responsible for entering the identity and quantity of said raw material.

42. The storage medium of claim 35, further including instructions for causing said processor to implement commencing production of said product if said raw material is acceptable.

43. The storage medium of claim 42, further including instructions for causing said processor to implement receiving quality data for said product.

44. The storage medium of claim 43, wherein said generating further includes said electronic production run sheet including said quality data for said product.

45. The storage medium of claim 43, wherein said receiving quality data is performed at a predetermined interval.

46. The storage medium of claim 43, wherein said receiving quality data occurs automatically in response to a change in said quality data which is greater than a predetermined threshold.

47. The storage medium of claim 42, further including instructions for causing said processor to implement receiving production line data for said product.

48. The storage medium of claim 47, wherein said generating further includes said electronic production run sheet including said production line data for said product.

49. The storage medium of claim 47, wherein said receiving production line data is performed at a predetermined interval.

50. The storage medium of claim 47, wherein said receiving production line data occurs automatically in response to a change in said production line data which is greater than a predetermined threshold.

51. The storage medium of claim 35, wherein said generating further includes instructions for causing said processor to implement supplemental user comments.

52. A computer data signal for electronic raw material tracking and quality control corresponding to a product on a production line, said computer data signal comprising code configured to cause a processor to implement a method comprising:
receiving inventory data corresponding to raw material for said product;
generating an electronic production schedule for said product;
generating an electronic production run sheet including said inventory data;
receiving a product selection from said electronic production schedule;
receiving a quantity selection for said product from said electronic production schedule;
downloading data from said electronic production schedule to said electronic production run sheet; and
determining whether said raw material is acceptable for said product in said quantity based on said inventory data.

53. The computer data signal of claim 52, wherein said computer data signal is embodied in a carrier wave.

54. The computer data signal of claim 52, wherein said computer data signal is unmodulated.

55. The computer data signal of claim 52, wherein said determining whether said raw material is acceptable includes code configured to cause said processor to implement:
determining the quality of said raw material;
updating said inventory data based on said determining the quality of said raw material; and
determining a usable quantity of said raw material based on said updating said inventory data.

56. The computer data signal of claim 55, further including code configured to cause said processor to implement:
receiving an electronic production schedule for said product;
determining raw material requirements based on said electronic production schedule; and
determining whether said usable quantity of said raw material meets said raw material requirements.

57. The computer data signal of claim 56, further including code configured to cause said processor to implement commencing production of said product if said usable quantity of said raw material meets said raw material requirements.

58. The computer data signal of claim 56, further including code configured to cause said processor to implement receiving additional raw material if said usable quantity of said raw material does not meet said raw material requirements.

59. The computer data signal of claim 55, wherein said determining the quality of said raw material includes code configured to cause said processor to implement:
comparing the physical properties of said raw material to a raw material specification; and
determining whether said physical properties of said raw material are within said raw material specification.

60. The computer data signal of claim 52, wherein said receiving inventory data includes code configured to cause said processor to implement:
receiving the identity and quantity of said raw material; and
receiving the identity of an operator responsible for entering the identity and quantity of said raw material.

61. The computer data signal of claim 52, further including code configured to cause said processor to implement commencing production of said product if said raw material is acceptable.

62. The computer data signal of claim 61, further including code configured to cause said processor to implement receiving quality data for said product.

63. The computer data signal of claim 62, wherein said generating further includes said electronic production run sheet including said quality data for said product.

64. The computer data signal of claim 62, wherein said receiving quality data is performed at a predetermined interval.

65. The computer data signal of claim 62, wherein said receiving quality data occurs automatically in response to a change in said quality data which is greater than a predetermined threshold.

66. The computer data signal of claim 61, further including code configured to cause said processor to implement receiving production line data for said product.

67. The computer data signal of claim 66, wherein said generating further includes said electronic production run sheet including said production line data for said product.

68. The computer data signal of claim 66, wherein said receiving production line data is performed at a predetermined interval.

69. The computer data signal of claim 66, wherein said receiving production line data occurs automatically in response to a change in said production line data which is greater than a predetermined threshold.

70. The computer data signal of claim 52, wherein said generating further includes code configured to cause said processor to implement supplemental user comments.
